(19) United States
(12) Patent Application Publication
(10) Pub. No.: US 2010/0182144 A1
(43) Pub. Date: Jul. 22, 2010

(54) RFID MAGNETIC SHEET, NONCONTACT IC CARD AND PORTABLE MOBILE COMMUNICATION APPARATUS

(75) Inventors: Yoshihisa Yamashita, Kyoto (JP); Seiichi Nakatani, Osaka (JP); Takashi Ichiryu, Osaka (JP); Fumio Fukushima, Miyazaki (JP); Kuniaki Kiyosue, Miyazaki (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi, Osaka (JP)

(21) Appl. No.: 12/376,661

(22) PCT Filed: Aug. 6, 2007
(86) PCT No.: PCT/JP2007/065372

§ 371 Date: Feb. 6, 2009

(30) Foreign Application Priority Data
Aug. 8, 2006 (JP) 2006-215299

(51) Int. Cl. G08B 1/08; G06K 19/077; G06K 19/06; B32B 38/10

(52) U.S. Cl. 340/539.11; 235/492; 235/493; 216/22

(57) ABSTRACT

Provided is a RFID magnetic sheet to be attached to an IC tag. The RFID magnetic sheet is provided with a plurality of stripe arranged layers (11a, 11b) whereupon a plurality of magnetic stripes (12) composed of a metal magnetic material are arranged at intervals, and a resin film (10) interposed between the respective stripe arranged layers. The arrangement relationship between the stripe arranged layers is set so that the magnetic stripes on each of the stripe arranged layers intersect with the magnetic stripes on the other stripe arranged layer in a planar shape.

### TECHNICAL FIELD

The present invention relates to a RFID magnetic sheet used for a RFID (Radio Frequency Identification) system for communicating with external equipment via an electromagnetic signal. The present invention relates also to a noncontact IC card and a portable mobile communication apparatus using the RFID magnetic sheet.

### BACKGROUND ART

In recent years, it is becoming more common to utilize a RFID system, which is an automatic recognition technology that uses as a signal carrier an electromagnetic field of a specific frequency emitted from external equipment, and performs communications of ID (Identification) information and various data with the external equipment. IC telephone cards, electronic tickets, and electronic money cards are examples of noncontact IC cards that use a RFID system, and recently this RFID is installed and used also in mobile telephones.

In the case of installing and using a RFID system on a portable mobile communication apparatus such as a mobile telephone, it is necessary to ensure a communication distance. For this purpose, the elimination of influence by magnetic path obstacles is sought. More specifically, there is the drawback that when a metal is adjacent to a RFID antenna in the RFID system, communications become impossible. In particular, in the case of using an electromagnetic signal of a high frequency such as 13.56 MHz, problems in the RFID system caused by this drawback are significant. In order to solve this problem, it is common to provide the RFID antenna with a magnetic sheet including ferrite with high magnetic permeability (see Patent document 1 for example).

FIGS. 1 to 3 will be referred to in describing the problem of not being able to communicate when metal is adjacent to the RFID antenna.

FIG. 1 is a cross-sectional view showing the operation of a typical RFID system 100. In the RFID system 100, a RFID antenna (tag antenna) 102 is attached to an IC tag 101 that is one example of a noncontact IC card, and a reader-writer antenna 104 is attached to a reader-writer 103. When communicating, the IC tag 101 is positioned close to the reader-writer 103. From the reader-writer antenna 104 of the reader-writer 103, a magnetic flux loop 105 is generated. RFID wireless communications between the IC tag 101 and the reader-writer 103 are made possible by a magnetic flux loop 105a that passes through both the antennas (the tag antenna 102 and the reader-writer antenna 104). FIG. 1 shows a schematic view of the communication state in the case where there are no metal products in the vicinity of the IC tag 101.

FIG. 2 schematically shows the communication state in a RFID system 110 like in FIG. 1, in the case where there is a metal product 106 in the vicinity of the IC tag 101. In this case, an eddy current is generated in the metal product 106 positioned in the vicinity of the IC tag 101 by a magnetic field from the reader-writer 103. Further, a magnetic field (demagnetizing field) 107 generated by this eddy current cancels a magnetic flux loop 105b required for communications. As a result, communications become difficult.

Consequently, when the metal product 106 is located adjacent to the IC tag 101, as shown in FIG. 3, a magnetic sheet 108 is interposed between the IC tag 101 and the metal product 106. Since the magnetic sheet 108 includes ferrite with a high magnetic permeability, a magnetic flux loop 105c can be concentrated on the magnetic sheet 108. As a result, it is possible to suppress the generation of an eddy current in the metal product 106 and to improve the communication distance.

The effect of the magnetic sheet 108 will be described in further detail with reference to FIGS. 4A and 4B. First, in the case where there is no magnetic sheet as shown in FIG. 4A, a magnetic flux loop 105d indicated with a broken line is lost under the influence of a magnetic field (demagnetizing field) generated by an eddy current in the metal product 106 located in the vicinity of the IC tag (IC tag antenna 102) by the magnetic field from the reader-writer. As a result, a magnetic field required for communications is canceled.

On the other hand, when the magnetic sheet 108 is used as shown in FIG. 4B, a magnetic flux loop 105e is concentrated on the magnetic sheet 108 because the value μ′ (real part) of the magnetic permeability of the magnetic sheet 108 is high. Furthermore, because the μ″ (imaginary part) of the magnetic permeability of the magnetic sheet 108 is low, the magnetic flux loop 105e flows without magnetic loss. As a result, the communication distance can be improved.

Patent document 1: JP 2004-227046 A

### DISCLOSURE OF INVENTION

### Problem to be Solved by the Invention

However, the magnetic field 108 including ferrite has the following problems. First, in the case of a magnetic sheet in which ferrite is dispersed in a resin, due to the configuration in which magnetic material (ferrite) is dispersed in the resin, there is an upper limit to the effective magnetic permeability μ. In the case of a configuration using a sintered body of ferrite (ceramic) instead of dispersing ferrite in the resin, the effective magnetic permeability μ increases, but the magnetic sheet becomes brittle as it is a sintered body. Moreover, there is a limitation both in the flexibility and in decreasing thickness of the magnetic sheet of a sintered body.

In order to achieve both flexibility and a high magnetic permeability μ, it would be possible to use a metal magnetic material for the magnetic sheet. In such a case, the μ becomes higher in comparison with the case of using ferrite. However, the magnetic sheet generates an eddy current because of its electrical conductivity, and thus obstructs the communications. Therefore, it is realistically difficult to use a metal magnetic material as the magnetic sheet.

Therefore, with the foregoing in mind, it is an object of the present invention to provide, first of all, a thin and flexible magnetic sheet with a high magnetic permeability.

### Means for Solving Problem

A RFID sheet of the present invention includes a plurality of stripe arranged layers each having a plurality of magnetic stripes of a metal magnetic material arranged at intervals, and a resin film interposed between the respective stripe arranged layers. The mutual positional relationship between the plural stripe arranged layers are set so that the magnetic stripes on each of the stripe arranged layers intersect with the magnetic stripes on the other stripe arranged layers in a planar shape.

A method for producing a RFID magnetic sheet of the present invention includes: a step (a) of forming a stripe arranged layer by arranging a plurality of magnetic stripes of a metal magnetic material on a resin film at intervals; and a step (b) of laminating a plurality of the resin films on which the stripe arranged layers are formed, so that the resin films are interposed between the respective stripe arranged layers. In the lamination step (b), the resin films are laminated with the mutual positional relationship being set so that the magnetic stripes on each of the stripe arranged layers intersect with the magnetic stripes on the other stripe arranged layer in a planar shape.

A method for producing an IC tag of the present invention includes: a step (a) of forming a stripe arranged layer by arranging a plurality of magnetic stripes of a metal magnetic material on a resin film at intervals; a step (b) of laminating a plurality of the resin films on which the stripe arranged layers are formed, so that the resin films are interposed between the respective stripe arranged layers; and a step (c) of laminating a resin film on which a pattern of a RFID antenna coil is formed, on the laminated body of the resin films laminated in the step (b). In the lamination step (b), the resin films are laminated with the mutual positional relationship being set so that the magnetic stripes on each of the stripe arranged layers intersect with the magnetic stripes on the other stripe arranged layer in a planar shape.

### Effects of the Invention

The RFID magnetic sheet of the present invention as mentioned above is configured to have patterns provided by magnetic stripes arranged on a plurality of stripe arranged layers intersecting with each other in a planar shape. Thereby, a thin and flexible RFID magnetic sheet on which an influence by an eddy current is suppressed can be provided.

The method for producing a RFID magnetic sheet of the present invention is suitable for producing the RFID magnetic sheet having the above configuration.

The method for producing an IC tag of the present invention is suitable for producing an IC tag including the RFID magnetic sheet having the above configuration.

### BRIEF DESCRIPTION OF DRAWINGS

FIG. 1 is a cross-sectional view for explaining a communication state in a RFID system.

FIG. 2 is a cross-sectional view for explaining another communication state in a RFID system.

FIG. 3 is a cross-sectional view showing an effect of a magnetic sheet in a RFID system.

FIG. 4A is a cross-sectional view showing an operation during communications in a state lacking the magnetic sheet.

FIG. 4B is a cross-sectional view for explaining in detail an effect of the magnetic sheet.

FIG. 5A is a plan view schematically showing a top surface configuration of an IC tag.

FIG. 5B is a cross-sectional view schematically showing a cross-sectional configuration of a RFID magnetic sheet attached to the IC tag.

FIG. 6A is a cross-sectional view schematically showing the configuration of the RFID magnetic sheet 2 according to First embodiment of the present invention.

FIG. 6B is an exploded perspective view of the RFID magnetic sheet 2.

FIG. 7A is a cross-sectional view showing a step of a method for producing a RFID magnetic sheet according to Second embodiment of the present invention.

FIG. 7B is a cross-sectional view showing a step following FIG. 7A.

FIG. 7C is a cross-sectional view showing a step following FIG. 7B.

FIG. 7D is a cross-sectional view showing a step following FIG. 7C.

FIG. 8A is a cross-sectional view showing a step of a method for producing a RFID magnetic sheet according to Third embodiment.

FIG. 8B is a cross-sectional view for describing a step following FIG. 8A.

FIG. 8C is a cross-sectional view showing a step following FIG. 8B.

FIG. 9A is a cross-sectional view showing another example of the method for producing a RFID magnetic sheet according to Third embodiment.

FIG. 9B is a cross-sectional view showing a step following FIG. 9A.

FIG. 9C is a cross-sectional view showing a step following FIG. 9B.

FIG. 9D is a cross-sectional view showing a step following FIG. 9C.

FIG. 10 is an exploded perspective view showing a mobile telephone according to Fourth embodiment of the present invention, equipped with the RFID magnetic sheet.

FIG. 11 is a plan view showing a variation of a RFID magnetic sheet according to Fifth embodiment.

FIG. 12 is a plan view showing another variation of the RFID magnetic sheet according to Fifth embodiment.

FIG. 13 is a plan view showing still another variation of the RFID magnetic sheet according to Fifth embodiment.

FIG. 14 is a partial enlarged plan view of magnetic stripes of the RFID magnetic sheet shown in FIG. 13.

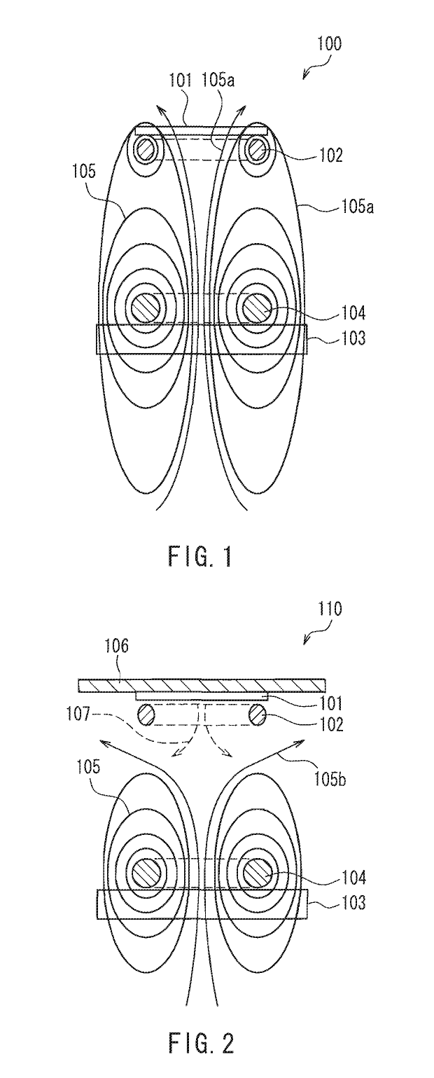

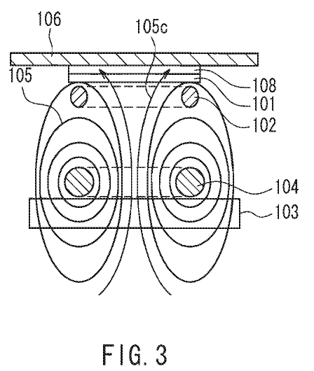

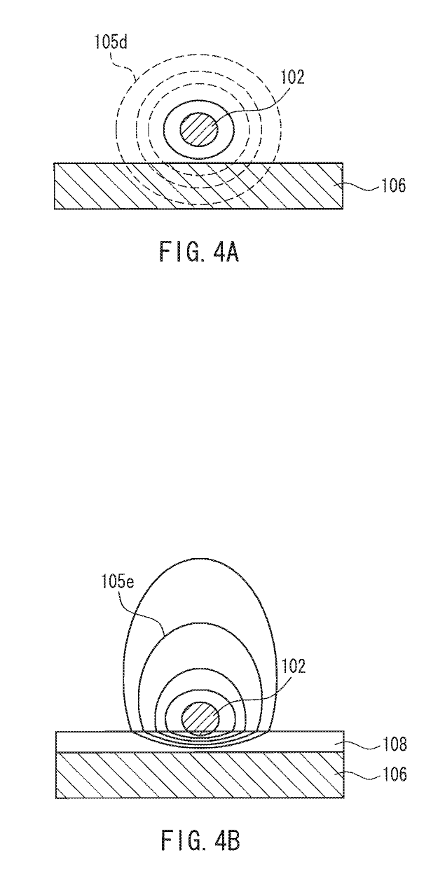

### EXPLANATION OF LETTERS AND NUMERALS

1 IC tag

2 magnetic sheet

3 card

4 IC chip

5 coil antenna

6 adhesive layer

10 resin film

11,11a,11b stripe arranged layer

12,12a,12b,12c,12d,12e,17 magnetic stripes

13,19 metal magnetic material layer

14 adhesive layer

15 nonmagnetic material layer (copper layer)

16,18 nonmagnetic stripes

18a fine-line linkage site

20 mobile telephone

21 mobile telephone body

22 battery pack

23 lid

100,110 RFID system

101 IC tag

102 tag antenna

103 reader-writer

104 reader-writer antenna

105,105a-105e magnetic flux loop

106 metal product

107 magnetic field (demagnetizing field)

108 magnetic sheet

### DESCRIPTION OF THE INVENTION

For providing a thin and flexible RFID magnetic sheet while ensuring a high magnetic permeability, the inventors have focused attention on a metal magnetic material that causes an adverse effect due to an eddy current because of its own electrical conductivity, and arrived at a concept of a configuration for eliminating obstacles in use, thereby making the metal magnetic material available. The metal magnetic materials having electrical conductivity and thus generating an eddy current have not been used for conventional RFID sheets. However, metals can be processed to be thin and flexible, and some types of metals have high magnetic permeability. Therefore, a metal magnetic material can be used preferably for composing a RFID magnetic sheet, as long as the problem of eddy current is solved.

In the present invention, the metal magnetic material is shaped as magnetic stripes so as to decrease influences due to generation of eddy current, and the magnetic stripes are laminated to form a lattice pattern so as to facilitate the passage of a magnetic flux loop. In this manner, the metal magnetic material can be applied to the RFID magnetic sheet.

The aspect of the present invention can be varied based on the above configuration.

Namely, it is preferable in the RFID magnetic sheet of the present invention that the widths of the magnetic stripes are set to a range for substantially avoiding flow of an eddy current caused by an electromagnetic signal applied for communications with the IC tag.

It can be configured such that it has both the stripe arranged layers of a row pattern and the stripe arranged layers of a column pattern, and that a lattice pattern is formed by the combination of the row pattern and the column pattern.

The stripe arranged layers can include magnetic stripes that extend diagonally with respect to the row pattern and the column pattern.

The metal magnetic material can be a soft magnetic material.

The metal magnetic material can be nickel or a nickel-based alloy.

The magnetic stripes can be formed of copper foil stripes formed on the resin film and a metal magnetic material plated on the copper foil stripes.

The resin film can be made of an aramid resin.

A noncontact IC card of the present invention can include any of the above-mentioned RFID magnetic sheets, a RFID antenna coil disposed adjacent to the RFID magnetic sheet, and an IC chip connected to the RFID antenna coil.

A portable mobile communication apparatus of the present invention can include any of the above-mentioned RFID magnetic sheets, a RFID antenna coil disposed adjacent to the RFID magnetic sheet, and an IC chip connected to the RFID antenna coil.

It is preferable in the method for producing a RFID magnetic sheet of the present invention that in the lamination step (b), the resin films are laminated so that the magnetic stripes on the respective stripe arranged layers define a lattice pattern.

It is also preferable that in the lamination step (b), the resin films are laminated such that the magnetic stripes of the row pattern and the magnetic stripes of the column pattern intersect with each other at an angle of 90° so as to define the lattice pattern when viewed from the normal direction of the resin films.

The lattice pattern can be composed of magnetic stripes extending in a first direction, magnetic stripes extending in a second direction, and magnetic stripes extending in a third direction.

The step (a) of forming the magnetic stripes can include: preparing a lamination film composed of the resin film on which a copper layer is laminated; forming stripes of copper by etching the copper layer of the lamination film; and forming the magnetic stripes of the metal magnetic material by plating the metal magnetic material on the stripes of copper.

The metal magnetic material can be nickel or a nickel-based alloy.

Alternatively, the step (a) of forming the magnetic stripes can include: preparing a lamination film composed of the resin film on which the metal magnetic material is laminated; and forming the magnetic stripes of the metal magnetic material by etching the metal magnetic material of the lamination film.

Alternatively, the step (a) of forming the magnetic stripes can include depositing the metal magnetic material on the resin film by using a mask of a stripe pattern.

Embodiments of the present invention will be described below with reference to the drawings. In the drawings below, in order to simplify descriptions, components having essentially the same functions are given the same reference numerals, and their descriptions are not repeated. Note that the present invention is not limited to the embodiments below.

### First Embodiment

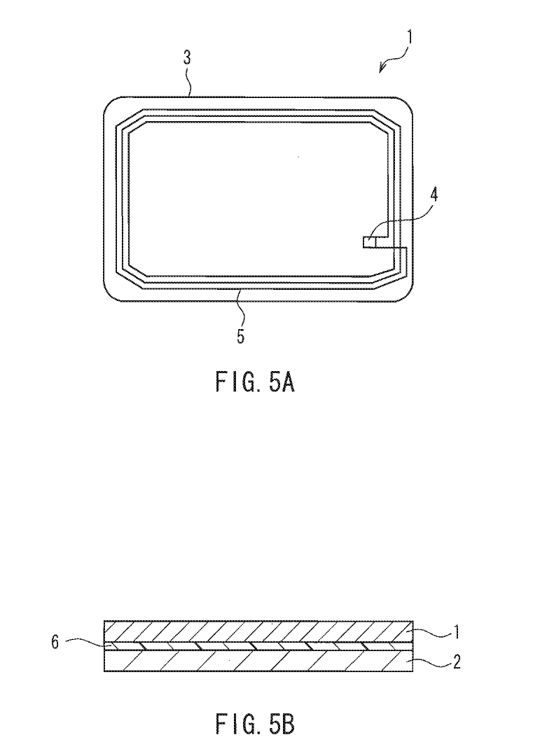

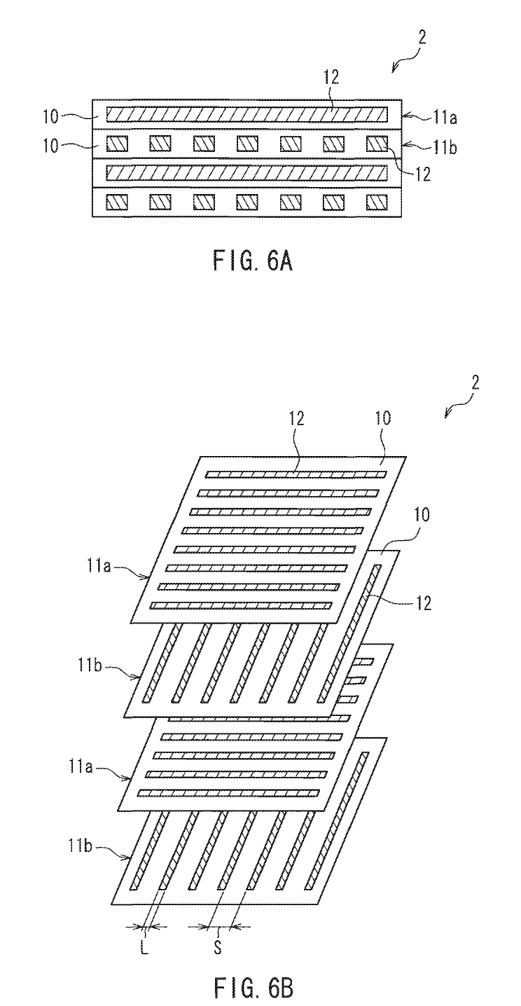

A RFID magnetic sheet according to First embodiment of the present invention will be described with reference to FIGS. 5A and 5B as well as FIGS. 6A and 6B.

FIG. 5A schematically shows a top configuration of an IC tag 1 in which the RFID magnetic sheet of the present embodiment is used. FIG. 5B schematically shows the cross-sectional configuration in the state in which a RFID magnetic sheet 2 is attached to the IC tag 1.

The IC tag 1 includes a card 3 as a base, an IC chip 4 disposed on the card 3, and a coil antenna (antenna coil for RFID use) 5 connected electrically to the IC chip 4. This IC tag 1 is used as a noncontact IC card. A unique ID number is stored in the memory of the IC chip 4, and various information can be stored in the memory. The IC chip 4 has a built-in CPU and memory, and can perform code processing, authentication, and storage.

The RFID magnetic sheet 2 of the present embodiment is attached to the card 3 of the IC tag 1. Another layer may exist between the card 3 and the magnetic sheet 2, and, for example, an adhesion layer 6 can be provided as shown in FIG. 5B.

FIG. 6A schematically shows the cross-sectional configuration of the RFID magnetic sheet 2. FIG. 6B is a perspective view showing the magnetic sheet 2 in an exploded state. The magnetic sheet 2 has a laminated structure of the resin films 10 and the stripe arranged layers 11a, 11b Note that, with respect to the resin films 10 in the drawings, the hatching of the cross-section is omitted for making it easier to see.

Each of the stripe arranged layers 11a, 11b is formed by arranging on the resin film 10 a plurality of magnetic stripes 12 of a metal magnetic material in a predetermined pattern. In this drawing, the magnetic stripes 12 look like being implanted in the resin films 10. This configuration exhibits substantially the same functions.

In this structure, the plurality of magnetic stripes 12 in each of the stripe arranged layers 11a, 11b are arranged separately from one another so as to be insulated electrically. Also, the magnetic stripes 12 arranged on each of the stripe arranged layers 11a and 11b that are positioned one on top of the other are separated from each other between the respective layers by the resin film 10 so as to be insulated electrically.

With the laminated structure, a lattice pattern is formed by the combination of the stripe arranged layer 11a on which the magnetic stripes 12 are arranged in a row pattern and the stripe arranged layer 11b on which the magnetic stripes 12 are arranged in a column pattern. Note that the stripe arranged layer 11a and the stripe arranged layer 11b differ only in the orientation of the magnetic stripes 12, but their materials and structures are identical to each other. Therefore, in the case of collectively referring to these stripe arranged layers below, they will be referred to as stripe arranged layer 11, with the reference numeral “11”.

The metal magnetic material composing the magnetic stripes 12 is a soft magnetic material for which metal or alloy having a high magnetic permeability is used. The examples include nickel, cobalt, and Permalloy (Ni—Fe alloy). Ceramics such as ferrite are not included in the examples of the metal magnetic materials. In Examples with reference to the present embodiment, nickel or an alloy containing nickel (particularly a nickel-based alloy) is used for the metal magnetic material.

As shown in FIG. 6B, the stripe arranged layers 11a of the row pattern and the stripe arranged layers 11b of the column pattern are laminated alternately. In an example, the magnetic stripes 12 are thin lines of nickel. The width L (line) of the magnetic stripes 12 may be, for example 0.5 mm or less (50 μm to 300 μm as one example). The space S between the fine lines may be, for example, 0.5 mm or less (50 μm to 300 μm as one example). The fine line and space may be set appropriately according to the use conditions.

An eddy current generated becomes easier to flow as the width L (line) of the fine lines becomes bigger, and the generation of the eddy current can be inhibited as L becomes smaller. Therefore, the width L is correlated with the eddy current, and so it is set to suppress the eddy current. Thus, the narrower L is preferred. Practically, taking the process limitation and process accuracy into consideration, the width of the magnetic stripes is set to a range for substantially preventing flow of an eddy current caused by an electromagnetic signal applied for communications with the IC tag. For example, it will be 50 μm to 300 μm as described above. Here, “substantially preventing flow of an eddy current” denotes that the eddy current is limited to a range not causing problems in use.

Also, with respect to the space S of the fine lines, the magnetic flux (actually the electromagnetic wave that exists together with the electrical wave and whose frequency is changing) becomes more leaky as S becomes bigger, and the leakage of the magnetic flux can be prevented as S becomes smaller. Therefore, the space S is correlated with the leakage (shield effect) of the electromagnetic wave, and is set to suppress leakage. And thus, the smaller S is preferred. Practically, when taking the process limitation and process accuracy into consideration, for example it will be 50 μm to 300 μm as described above.

When considering the function of suppressing the eddy current and the electromagnetic wave leakage, it is better for the width L and the space S to be as small as possible. This means that the fine lines provided at the higher density are preferable, and consequently, this leads to an increase in the amount of magnetic substance per unit volume. As a result, it is possible to realize a magnetic sheet with a high net magnetic permeability.

Typically, the stripe arranged layers 11a of the row pattern intersect at an angle of 90° with the stripe arranged layers 11b of the column pattern, but the intersection does not necessarily have to occur at 90°. For example, it is possible to form a lattice pattern of the magnetic stripes by intersecting at an angle such as 60° or 45°. Also, it is possible to superimpose a stripe arranged layer of yet another pattern on the stripe arranged layer 11a of the row pattern and the stripe arranged layer 11b of the column pattern.

In short, the lattice pattern formed by the laminated structure of the stripe arranged layers is obtained by disposing the stripe arranged layers such that the magnetic stripes on each of the stripe arranged layers intersects with the magnetic stripes on the other stripe arranged layers in the planar shape. It is necessary to obtain the function of facilitating the passage of the magnetic flux loop in this manner.

The stripe arranged layers 11a and 11b each are formed on the resin film 10, but it is possible to provide other layers (e.g., adhesive layers) on the resin film 10 and the stripe arranged layers 11a and 11b. In addition, it is possible to form the magnetic stripes inside the resin film 10. In any case, the space between the stripe arranged layers 11 of each layer is configured to be electrically insulative.

The resin film 10 can be selected appropriately in accordance with the use, performance, and conditions. For example, an aramid resin film, a polyimide resin film, a polyethylene terephthalate resin film, a polyethylene naphthalate resin film and the like can be used. As a thin (e.g., 9 μm or less) aramid resin film having an excellent heat resistance is available, there are cases where it is preferable to use an aramid resin film in view of the thinness when the number of layers is considered.

The RFID magnetic sheet 2 of the present embodiment includes a resin film 10 and stripe arranged layers composed of arranged magnetic stripes 12 of a metal magnetic material. Magnetic stripes 12 are disposed in a lattice pattern by the combination of the stripe arranged layer 11a of the row pattern and the stripe arranged layer 11b of the column pattern.

Since this magnetic sheet 2 is made using a metal magnetic material as a magnetic material, it can exhibit a high magnetic permeability thereby decreasing the leakage of the magnetic field. When the metal magnetic material is used, more eddy current may be generated due to the electrical conductivity of the metal magnetic material. However, since separate and spaced fine lines (strips) are used, the influence of the eddy current generation is suppressed considerably. Here, if the effect of decreasing the leakage of magnetic field is remarkably higher than the effect of the demagnetizing field caused by the eddy current, improvement of communication distance can be achieved.

Further, by using the metal magnetic material, the RFID magnetic sheet 2 of the present embodiment can be made thinner and more flexible in comparison with a case using a ceramic magnetic material (ferrite). Therefore, the RFID magnetic sheet 2 of the present embodiment is used preferably for a noncontact IC card (specifically a noncontact IC card to be built in a mobile telephone).

### Second Embodiment

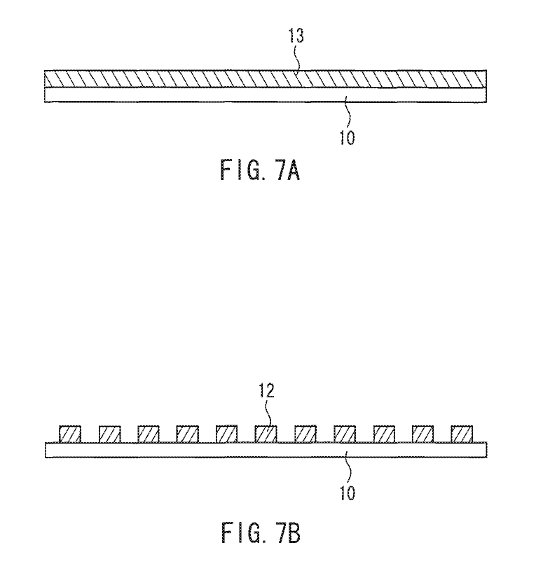

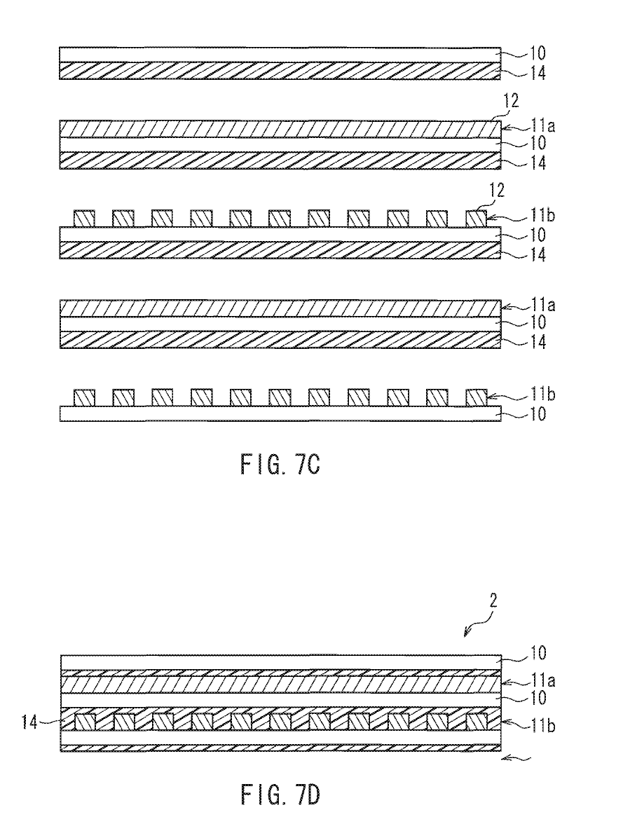

A method for producing a magnetic sheet 2 in Second embodiment of the present invention will be described below with reference to FIGS. 7A to 7D.

First, as shown in FIG. 7A, a metal magnetic material layer 13 is formed on a resin film 10. The thickness of the resin film 10 is set to 4 μm or more, for example. Since a plurality of the resin layers 10 are laminated in the final stage, it is preferable that each of the resin films 10 is thin so that the thickness of the RFID magnetic sheet 2 can be decreased. The resin film 10 is made of an aramid resin for example. The metal magnetic material layer 13 is made of a soft magnetic metal for example, and nickel can be used in an example. The thickness of the metal magnetic material layer 13 is 5 μm or more. The thickness or the material of the resin film 10 and the metal magnetic material layer 13 can be determined suitably in accordance with the properties of the magnetic sheet 2 to be produced.

Next, as shown in FIG. 7B, the metal magnetic material layer 13 is etched to have a predetermined pattern so as to form magnetic stripes 12 of fine lines of a metal magnetic material. When the metal magnetic material layer 13 is made of nickel, it can be etched by using a mixture solution of sulfuric acid and hydrogen peroxide, nitric acid or the like as an etchant.

Alternatively, the magnetic stripes 12 can be formed by sputtering. Specifically, the metal magnetic material layer 13 is deposited on a resin film 10 by using a stripe pattern mask. Thereby, magnetic stripes 12 of fine lines of a metal magnetic material can be formed. In an alternative formation method, magnetic stripes 12 formed on another carrier film can be transferred onto the resin film 10, instead of forming directly the magnetic stripes 12 on the resin film 10.

Next, as shown in FIG. 7C, the stripe arranged layers and the resin films 10 are laminated so that the magnetic stripes 12 formed on the respective resin films 10 shape a lattice pattern. In the lamination, the stripe arranged layers 11a of the row pattern and stripe arranged layers 11b of the column pattern are disposed alternately. An adhesive layer 14 is provided between the respective resin films 10. The adhesive layer 14 is formed of an adhesive such as an epoxy resin. Alternatively, it is possible to use a resin film 10 provided with adhesiveness on its certain surface, instead of providing the adhesive layer 14.

Later, a lamination step is carried out and, as shown in FIG. 7D, the respective resin films 10 are adhered to form a laminated body, thereby obtaining the RFID magnetic sheet 2 of the present embodiment. At this time, since the adhesive layer 14 partly enters the spacing between the respective magnetic stripes 12, as shown in the stripe arranged layer 11b of the column pattern, the thin part of adhesive layer 14 remains on the respective magnetic stripes 12. It should be noted that the adhesion for lamination is not necessarily carried out in the state as shown in FIG. 7D. In some cases, for example, substantially the whole part of the adhesion layers 14 enters the spacing between the respective magnetic stripes 12. Though the number of the laminated stripe arranged layers 11 (number of laminated resin films 10) can be decided in accordance with the desired properties of the magnetic sheet 2, at least six layers (in an example, 10 to 15 layers) are preferred.

Typically, the stripe arranged layer 11a of the row pattern and the stripe arranged layers 11b of the column pattern are laminated alternately and regularly. However, it is not always required to dispose the stripe arranged layer 11a of the row pattern and the stripe arranged layers 11b of the column pattern alternately in a strict sense as long as a lattice pattern can be observed when viewing the laminated body from above.

### Third Embodiment

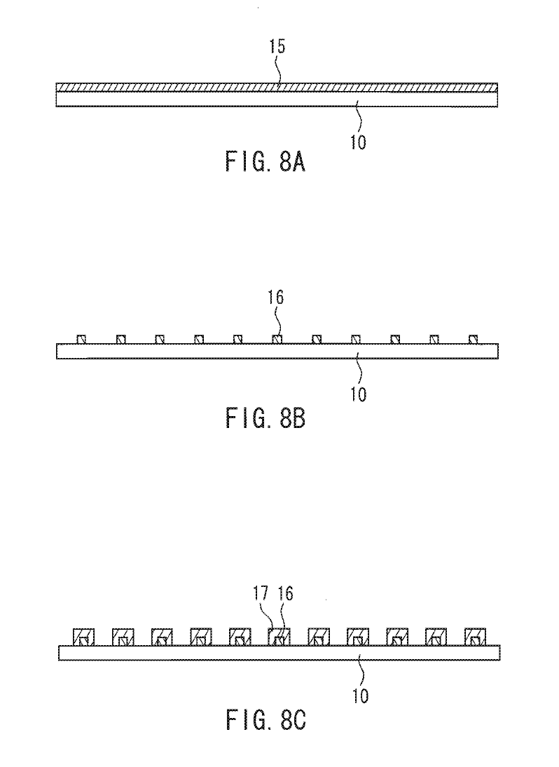

A method for producing a magnetic sheet in Third embodiment of the present invention will be described below with reference to FIGS. 8A to 8C.

In Second embodiment, magnetic stripes 12 of fine lines of a metal magnetic material (for example, nickel) are used as shown in FIG. 7B, but the present invention is not limited to this example. In an alternative example, it is possible to use a nonmagnetic material (for example, a nonmagnetic metal) at the center for defining the magnetic stripe pattern, and a metal magnetic material is adhered by plating to the periphery so as to form magnetic stripes of the metal magnetic material.

An example of the metals as the nonmagnetic materials is copper. For example, nickel or the alloy as a metal magnetic material is adhered by plating onto a copper pattern so as to form magnetic stripes of the metal magnetic material. An example of the nonmagnetic material is an electroconductive resin composition containing copper, and also aluminum, conductive filler and a resin.

FIGS. 8A to 8C show a process of shaping a nonmagnetic stripe pattern with copper and subsequently forming magnetic stripes of nickel.

First, as shown in FIG. 8A, for example a nonmagnetic material layer 15 such as a copper foil is formed on a resin film 10. Next, the nonmagnetic material layer 15 is etched to form nonmagnetic stripes (pattern of copper stripes) 16 as shown in FIG. 8B. The nonmagnetic stripes 16 may be formed by a method other than etching.

Later, as shown in FIG. 8C, a metal magnetic material is deposited by plating on the nonmagnetic stripes 16 so as to form magnetic stripes 17 of the metal magnetic material. When the metal magnetic material (soft magnetic metal) is for example nickel or cobalt, the magnetic stripes 17 can be formed by an electroless plating.

If an electrolytic plating can be applied as well as the electroless plating, the range of applicable metal magnetic materials will be increased. For example, soft iron, iron, silicon steel, Mu-metal, pure iron, Permalloy (Ni—Fe alloy), Sendust (Fe—Si—Al alloy), Supermalloy (Ni—Fe—Mo alloy) and the like can be used in addition to the above-mentioned nickel and cobalt. Alternatively, these materials can be etched for patterning if they are wet-etched with appropriate etchants.

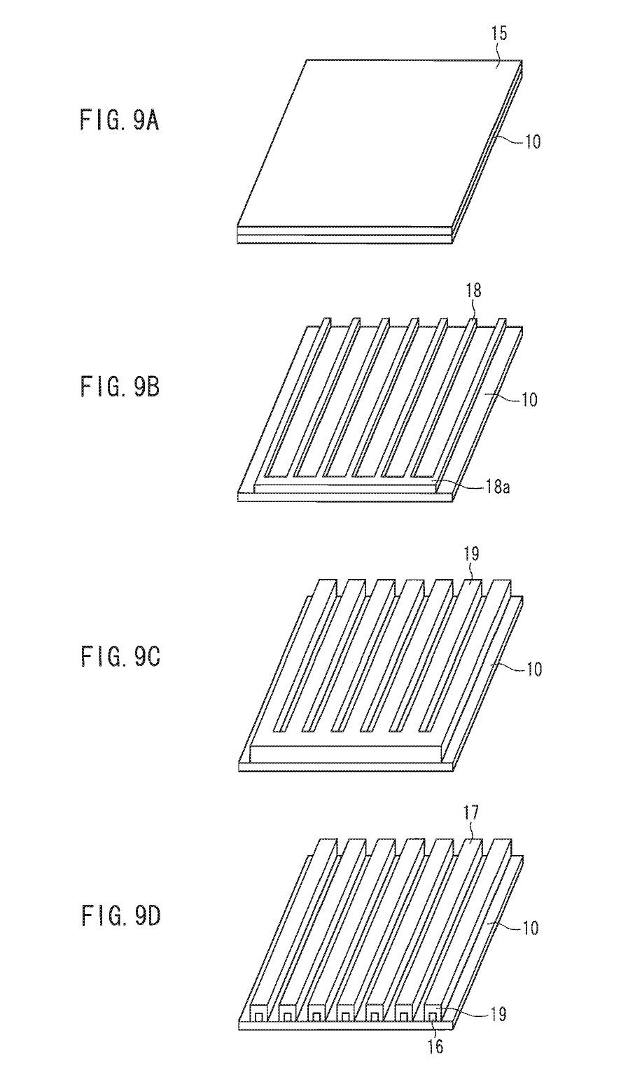

When electrolytic plating is preferable, the process shown in FIGS. 9A to 9D can be employed.

First, as shown in FIG. 9A, a resin film 10 on which a nonmagnetic material layer (for example, a copper layer) is formed is prepared. Next, as shown in FIG. 9B, the nonmagnetic material layer (copper layer) 15 is patterned to form nonmagnetic stripes 18. At this time, the nonmagnetic material layer 15 is patterned while a fine-line linkage site 18a for linking the respective nonmagnetic stripes 18 is kept for a common electrode.

Later, the nonmagnetic stripes 18 (including the fine-line linkage site 18a) are applied with voltage for electrolytic plating, thereby depositing a metal magnetic material layer 19 as shown in FIG. 9C. Finally, the fine-line linkage site 18a are cut off to obtain magnetic stripes 17 of independent fine lines as shown in FIG. 9D. By laminating the resin films 10 on which the magnetic stripes 17 are formed, the RFID magnetic sheet 2 of the present embodiment can be produced.

### Fourth Embodiment

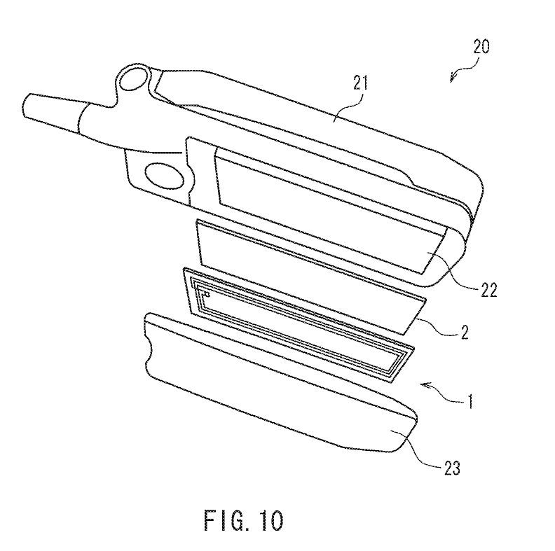

FIG. 10 is an exploded perspective view showing the configuration of a mobile telephone 20 according to Fourth embodiment. The mobile telephone 20 is equipped with the RFID magnetic sheet 2 of the above embodiments. That is, a main body 21 of the mobile telephone 20 is equipped with a battery pack 22, and an IC tag 1 is attached to that battery pack 22 via the RFID magnetic sheet 2, and a lid 23 seals the main body 21.

Since the metal battery pack 22 is installed in the main body 21 of the mobile telephone 20, if no measure is taken, the communication state of the IC tag 1 would deteriorate. However, in the present embodiment, since the RFID magnetic sheet 2 is provided, deterioration of the communication state can be repressed. The RFID magnetic sheet 2 has a high magnetic permeability, and at the same time, it can be made thin and flexible. Therefore, it is easy to obtain a thin mobile telephone 20 though the IC tag and the RFID magnetic sheet 2 are contained by using the lid 23 of the mobile telephone 20.

The RFID magnetic sheet according to the embodiments of the present invention may be used not only in mobile telephones, but also in portable mobile communication apparatuses such as PDAs. In addition, the

RFID magnetic sheet according to the embodiments of the present invention may be used by attaching it to a noncontact IC card (or IC tag) even when not being equipped on a portable mobile communication apparatus.

In addition, in the lamination step shown in FIGS. 7C and 7D, it is possible to laminate a film (resin film) on which a pattern of the RFID antenna coil is formed, on the laminated body of the resin films 10 on which the magnetic stripes 12 are formed, thereby creating the IC tag with a magnetic sheet. Alternatively, it is possible to form a metal layer (e.g., copper layer) on a laminated body, and to process the metal layer so as to form the pattern of the RFID antenna coil.

### Fifth Embodiment

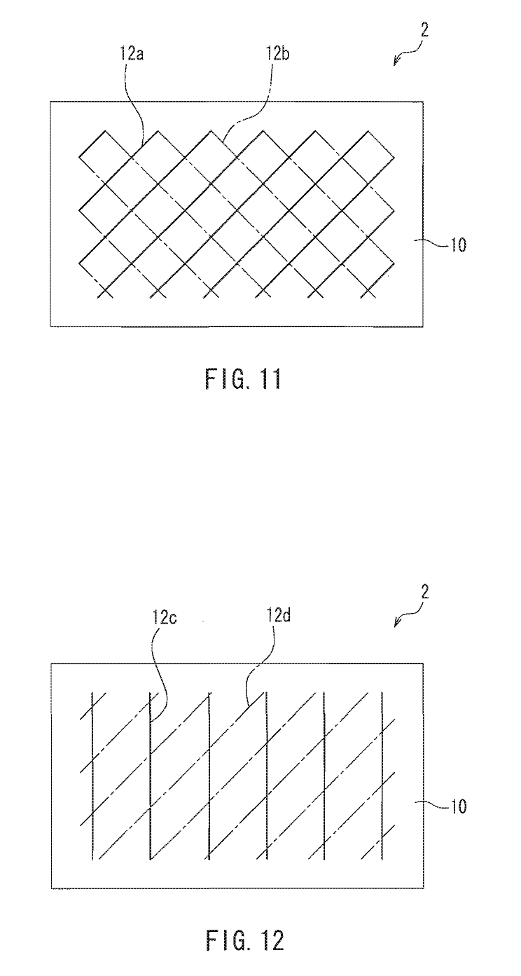

A RFID magnetic sheet according to Fifth embodiment will be described below with reference to FIGS. 11 to 14.

In each example of the RFID magnetic sheet 2 in the above embodiments, the stripe arranged layers 11a of the row pattern and the stripe arranged layers 11b of the column pattern are disposed to cross each other at 90°. However, the arrangement is not limited to this example. For instance, as shown in FIG. 11, it is possible to form magnetic stripes 12a, 12b diagonally on two resin films 10 respectively and to dispose them so that the magnetic stripes will cross each other when the resin films 10 are superimposed. Alternatively, as shown in FIG. 12, it is possible to form magnetic stripes 12c on a resin film 10 to have a row or column pattern, and the other magnetic stripes 12d extend diagonally so as to intersect with each other at an angle other than 90°.

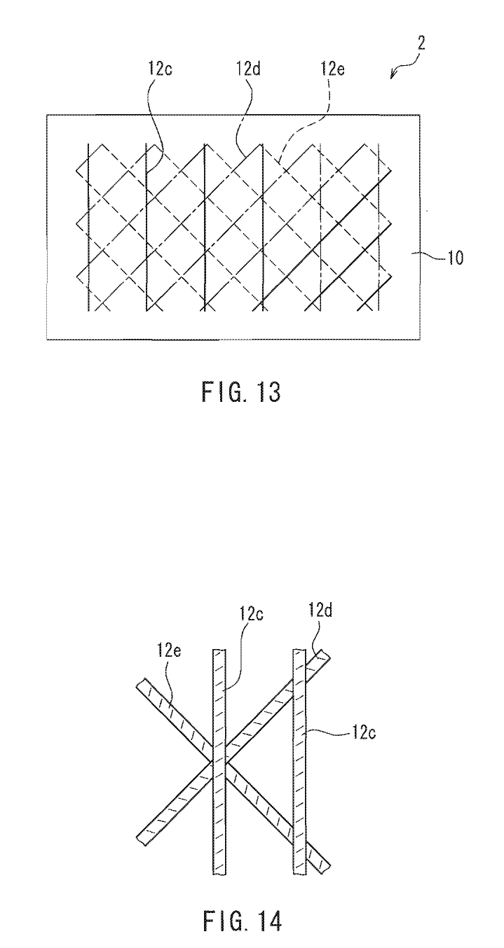

Alternatively, as shown in FIG. 13, magnetic stripes 12e of a pattern extending in a third direction can be added to the magnetic stripes 12c of a pattern extending in a first direction and the magnetic stripes 12d of a pattern extending in a second direction as shown in FIG. 12. FIG. 14 shows the arrangement of the fine lines of the magnetic stripes 12c-12e in a schematically enlarged manner.

In the case of intersecting the stripe arranged layer 11a of the row pattern and the stripe arranged layer 11b of the column pattern, there are cases where it is not necessary to unify the line (width) of the fine line of the magnetic stripe 12 and the space (interval) for every layer. However, from the point of view of manufacturing process, it is efficient to use magnetic stripes 12 with the same line and space for each layer.

The present invention is stated with reference to preferred embodiments. These statements above are not limitative but various modifications can be applied. For example, in the above embodiments, the fine lines composing the magnetic stripes are linear. However, the magnetic stripes can be composed of fine lines including curves as long as the respective fine lines are prevented from contacting with each other.

### INDUSTRIAL APPLICABILITY

According to the present invention, a thin and flexible magnetic sheet having a high magnetic permeability can be provided.

1. A RFID magnetic sheet to be attached to an IC tag, comprising: a plurality of stripe arranged layers each having a plurality of magnetic stripes of a metal magnetic material arranged at intervals; and a resin film interposed between the respective stripe arranged layers;
wherein a positional relationship between the plurality of stripe arranged layers is set so that the magnetic strips on each of the stripe arranged layers intersect with the magnetic stripes on the other stripe arranged layer in a planar shape, and
the magnetic stripes are formed of nonmagnetic stripes formed on the resin film and a metal magnetic material plated on the nonmagnetic stripes.

2. The RFID magnetic sheet according to claim 1, wherein the width of the magnetic stripes is set to a range to substantially prevent flow of an eddy current caused by an electromagnetic signal applied for communications with an IC tag.

3. The RFID magnetic sheet according to claim 1, comprising the stripe arranged layers of a row pattern and the stripe arranged layers of a column pattern, and a lattice pattern is formed by a combination of the row pattern and the column pattern.

4. The RFID magnetic sheet according to claim 3, wherein the stripe arranged layers comprise the magnetic stripes extending diagonally with respect to the row pattern and the column pattern.

5. The RFID magnetic sheet according to claim 1, wherein the metal magnetic material is a soft magnetic material.

6. The RFID magnetic sheet according to claim 5, wherein the soft magnetic material is nickel or a nickel-based alloy.

7. The RFID magnetic sheet according to claim 1, wherein the nonmagnetic stripes are copper foil stripes.

8. The RFID magnetic sheet according to claim 1, wherein the resin film is made of an aramid resin.

9. A noncontact IC card comprising:
the RFID magnetic sheet according to claim 1;
a RFID antenna coil disposed adjacent to the RFID magnetic sheet; and
an IC chip connected to the RFID antenna coil.

10. A portable mobile communication apparatus comprising:
the RFID magnetic sheet according to claim 1;
a RFID antenna coil disposed adjacent to the RFID magnetic sheet; and
an IC chip connected to the RFID antenna coil.

11. A method for producing a RFID magnetic sheet comprising:
a step (a1) of preparing a lamination film composed of a resin film on which a nonmagnetic material layer is laminated;
a step (a2) of etching the nonmagnetic material layer on the lamination film so as to form a plurality of nonmagnetic stripes of the nonmagnetic material arranged at intervals;
a step (a3) of forming a stripe arranged layer by plating a metal magnetic material on the nonmagnetic stripes so as to arrange a plurality of magnetic stripes of the metal magnetic material at intervals; and
a step (b) of laminating a plurality of the resin films on which the stripe arranged layer are formed, so that the resin films are interposed between the respective stripe arranged layers;
wherein in the lamination step (b), the resin films are laminated with the mutual positional relationship being set so that the magnetic stripes on one of the stripe arranged layers intersect with the magnetic stripes on the other stripe arranged layer in a planar shape.

12. The method for producing a RFID magnetic sheet according to claim 11, wherein in the lamination step (b), the resin films are laminated so that the magnetic stripes on the respective stripe arranged layers form a lattice pattern.

13. The method for producing a RFID magnetic sheet according to claim 12, wherein in the lamination step (b), the resin films are laminated so that the magnetic stripes of the row pattern and the magnetic stripes of the column pattern intersect with each other at an angle of 90° to form the lattice pattern when viewed from the normal direction of the resin films.

14. The method for producing a RFID magnetic sheet according to claim 11, wherein the lattice pattern is composed of the magnetic stripes extending in a first direction, the magnetic stripes extending in a second direction, and the magnetic stripes extending in a third direction.

15. The method for producing a RFID magnetic sheet according to claim 11, wherein in the step (al) of preparing the lamination film, a lamination film comprising a copper layer laminated as the nonmagnetic material layer is prepared.

16. The method for producing a RFID magnetic sheet according to claim 11, wherein the metal magnetic material is nickel or a nickel-based alloy.

17. (canceled)

18. (canceled)

19. A method for producing an IC tag comprising:
a step (a1) of preparing a lamination film composed of a resin film on which a nonmagnetic material layer is laminated;
a step (a2) of etching the nonmagnetic material layer so as to form a plurality of nonmagnetic stripes of a nonmagnetic material arranged at intervals;
a step (a3) of forming a stripe arrangement layer by plating a metal magnetic material on the nonmagnetic stripes so as to arrange a plurality of magnetic stripes of the metal magnetic material at interval;
a step (b) of laminating a plurality of the resin films on which the stripe arranged layers are formed, so that the resin films are interposed between the respective stripe arranged layers; and
a step (c) of laminating a resin film on which a RFID antenna coil pattern is formed, on the laminated body of the resin film laminated in the step (b);
wherein in the lamination step (b), the resin films are laminated with the mutual positional relationship being set so that the magnetic stripes on each of the stripe arranged layers intersect with the magnetic stripes on the other stripe arranged layer in a planar shape.
